(19) United States
(12) Patent Application Publication
(10) Pub. No.: US 2013/0276714 A1
(43) Pub. Date: Oct. 24, 2013

(54) Pet Litter Box

(71) Applicant: Rhonda Bauer, Broomfield, CO (US)

(72) Inventor: Rhonda Bauer, Broomfield, CO (US)

(21) Appl. No.: 13/235,291

(22) Filed: Sep. 16, 2011

Related U.S. Application Data
(63) Continuation-in-part of application No. 12/565,040, filed on Sep. 23, 2009, now abandoned.

(51) Int. Cl. A01K 1/01

(52) U.S. Cl. CPC A01K 1/0114
USPC 119/166

(57) ABSTRACT

The invention is directed to a pet litter box that has a lower portion having a bottom wall and four lower portion side walls that are at slightly more than ninety degrees from the bottom wall. An upper portion has a top wall and four upper portion side walls. A cutout portion in one of the four upper portion side walls forms a pet ingress and egress point. The four upper side walls terminate in a groove that mates with a lip formed by the four lower portion side walls. An internal divider has a floor grate that extends along a length of the lower portion and has a wall at approximately ninety degrees to the floor grate. The wall does not extend the length of the lower portion. Note that the lower portion has a height that is equal to or greater than the height of the upper portion.

### RELATED APPLICATIONS

This application is a continuation-in-part of and claims priority on U.S. patent application Ser. No. 12/565,040, entitled “Pet Litter Box” filed Sep. 23, 2009.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

It is common for cat owners to have a litter box in their house. The simplest litter box is a shallow rectangular box that holds the litter. Some owners use a plastic bag to encase the litter box. The plastic bag keeps the box clean and facilitates throwing out the used litter. However, this system does not keep other pets such as dogs from snacking or prevent the cat from tracking litter out of the box. Enclosed litter boxes have been produced and this helps to eliminate snacking, but does not prevent litter tracking. There have also been attempts to provide grates in litter boxes to prevent tracking. However, all these previous solutions have not prevented tracking because the cat just jumps over the grate, thereby defeating its purpose or the grate is just too short to be effective or the grate is contained in the lower section and the cat just steps out.

Another common problem with enclosed litter boxes is that some cats do not squat to urinate and the urine runs down the side walls and when it meets the junction between the upper and lower parts of the enclosure it seeps through the horizontal lips or grooves between and runs along the outside wall of the enclosure. This results in urine leaking on the floor. It has also been found that these enclosed litter boxes do not provide a substantial benefit in the reduction of odor from open litter boxes.

Thus there exists a need for a litter box that stops dog snacking, reduces tracking, stops urine leaks, limits circulation of odor and can be shipped inexpensively.

### BRIEF SUMMARY OF INVENTION

A pet litter box that overcomes these and other problems has a lower portion having a bottom wall and four lower portion side walls that are at slightly more than ninety degrees from the bottom wall. An upper portion has a top wall and four upper portion side walls. A cutout portion in one of the four upper portion side walls forms a pet ingress and egress point. The four upper side walls terminate in a vertical groove that mates with a lip formed by the four lower portion side walls. An internal divider has a floor grate that extends along a length of the lower portion and a wall. The wall does not extend the length of the lower portion. A divider groove mates with the lip of the lower portion, whereby a pet entering or exiting the pet litter box is required to make a turn on the grate. Forcing a cat to make a turn when exiting the litter box makes sure the cat does not just jump over the grate. This ensures that most of the litter on the cat's paws is removed while jumping onto the grate floor and walking along the grate floor. Also having the grate run along the length of the litter box forces the cat to take several steps on the grate before exiting.

The upper portion and internal divider of the litter box can be nested inside the lower portion for easy shipping. The lower portion has a height that is equal to or greater than the upper portion and is about the height of an average cat's head. The upper portion and grate floor bar dogs from snacking. Overlapping edges formed by vertical lips between the upper and lower portions of the litter box stops urine leaks.

### BRIEF DESCRIPTION OF THE SEVERAL VIEWS OF THE DRAWINGS

FIG. 1 is a top left perspective view of a pet litter box in accordance with one embodiment of the invention;

FIG. 2 is an exploded view of the pet litter box in accordance with one embodiment of the invention;

FIG. 3 is a top left perspective view of the pet litter box nested for shipping in accordance with one embodiment of the invention;

FIG. 4 is a side view of a cat;

FIG. 5 is a top view of a portion of a floor grate in accordance with one embodiment of the invention;

FIG. 6 is a cutaway view of the floor grate of FIG. 5, in accordance with one embodiment of the invention;

FIG. 7 is a side view section of the floor grate in accordance with one embodiment of the invention;

FIG. 8 is a cutaway view of the vertical lips of the pet liter box in accordance with one embodiment of the invention; and

FIG. 9 is a cutaway view of a hinge in accordance with on embodiment of the invention.

### DETAILED DESCRIPTION OF THE INVENTION

The invention is directed to a pet litter box that has a lower portion having a bottom wall and four lower portion side walls that are at slightly more than ninety degrees from the bottom wall. An upper portion has a top wall and four upper portion side walls. A cutout portion in one of the four upper portion side walls forms a pet ingress and egress point. The four upper side walls terminate in a groove that mates with a lip formed by the four lower portion side walls. An internal divider has a floor grate that extends along a length of the lower portion and has a wall at approximately ninety degrees to the floor grate. The wall does not extend the length of the lower portion. A divider groove mates with the lip of the lower portion, whereby a pet entering or exiting the pet litter box is required to make a turn on the grate. Forcing a cat to make a turn when exiting the litter box makes sure the cat does not just jump over the grate. This ensures that most of the litter on the cat's paws is removed while jumping onto the grate floor and walking along the grate floor. Also having the grate run along the length of the litter box forces the cat to take several steps on the grate before exiting.

The upper portion and internal divider of the litter box can be nested inside the lower portion for easy shipping. The lower portion has a height that is equal to or greater than the upper portion and is about the height of an average cat's head. The upper portion and grate floor bar dogs from snacking. Overlapping edges between the upper and lower portions of the litter box stops urine leaks.

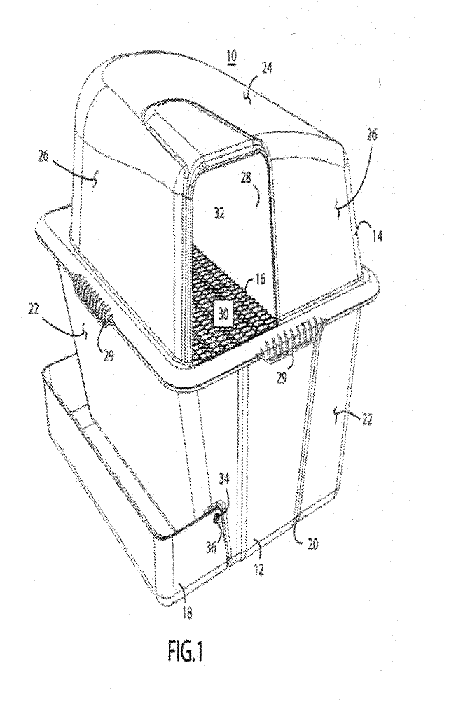

FIG. 1 is a top left perspective view of a pet litter box 10 in accordance with one embodiment of the invention. The litter box 10 has a relatively deep lower portion 12, a removable upper portion 14, an internal divider 16, and a storage shelf 18. The lower portion 12 has a bottom wall 20 and four upper portions side walls 22. The side walls 22 are angled at slightly more that ninety degrees from the bottom wall 20. The upper portion 14 has a top wall 24 and four upper side walls 26. The four upper side walls 26 are not perpendicular to the top wall 24. One of the four upper side walls 26 having an opening or cutout 28. The upper portion 14 has a plurality of handles 29. An internal divider 16 has a floor grate 30 that runs the length of the lower portion 12 and is adjacent to the opening 28. Note that the lower portion side walls 22 form a rectangular opening with a length and width. The internal divider 16 has an internal wall 32 that is perpendicular to the floor grate 30 and does not extend the complete length of the lower portion 12 or the upper portion 14. The wall 32 abuts the upper portion 14 to create a passageway. Where the wall 32 ends it creates a second opening from the floor grate 30 passageway into the lower portion 12. In one embodiment, the litter box 10 has a storage shelf 18. The storage shelf 18 has a plurality of openings 34 that snap fit onto a plurality of tabs 36 on the lower portion 12.

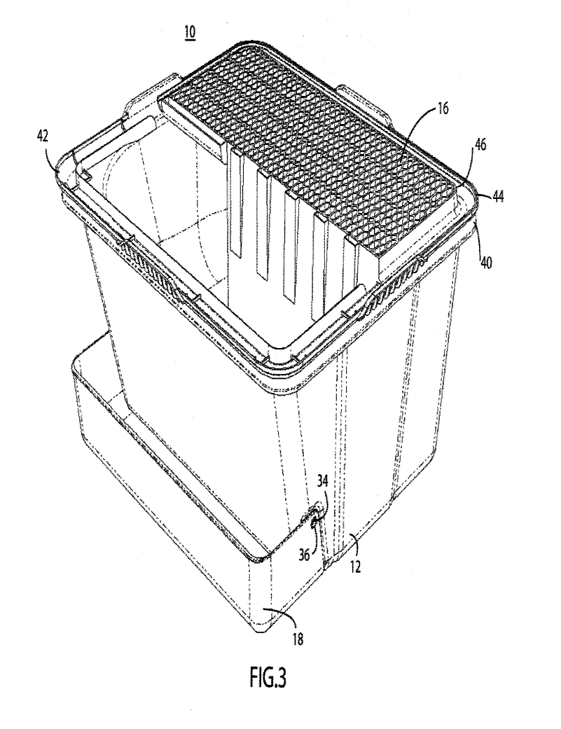

Note that the lower portion 12 has a height (h_{L}) and the upper portion 14 has a height (h_{L}) which is equal to or less than the lower portion height. This aides in the nesting of the two portions as seen in FIG. 3. But more importantly it ensures that cats that do not squat to urinate, often called “high pee-ers”, are not able to pee on the upper portion 14. This reduces the time and effort necessary to clean the litter box. Another advantage of the taller lower portion is that it traps the odors associated with the litter box better than enclosed litter boxes with short lower portions since air circulation is restricted. In one embodiment, the height of the lower portion 12 is higher than the average height (h_{C}) of a cat's head (see FIG. 4). In another embodiment, the lower portion height is at least eight inches. In yet another embodiment, the lower portion height is at least ten inches.

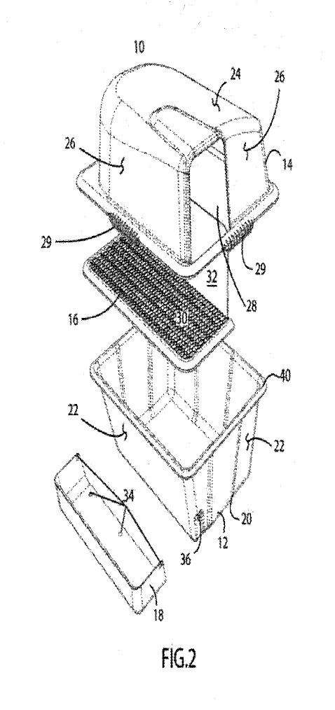

FIG. 2 is an exploded view of the pet litter box 10 in accordance with one embodiment of the invention. This view shows the lower portion 12 is a somewhat rectangular box with obtuse walls 22. The walls 22 terminate in a vertical lip 40 along the periphery of the walls 22. The upper portion 14 has a grove 42 (see FIG. 3) along part of a periphery and half grove or lip 44 along the rest of the periphery that mates with the lip 40 of the lower portion 12. The divider portion 16 includes a step 46 along its periphery. The step 46 and the half groove 44 form a full groove that mates with the lip 40 of the lower portion.

In one embodiment, the litter box 10 has a hinge 47 attaching one of the four lower portion side walls 22 to one of the four upper portion side walls 26. This hinge 47 is shown on the wall opposite of the grate 16, but it could be on any of the walls. The hinge allows for easy access to the litter box. This is particularly helpful with daily excrement removal.

In another embodiment, the upper portion 26 is split in half with a hinge 49 at the top. This allows access to clean the litter box 10. In one embodiment, the grate 30 snap fits to the upper portion 26.

In one embodiment, the lower portion 12 is made of an antimicrobial or antibacterial material, such as a plastic embedded with silver particles. In another embodiment, the upper portion 14 is also made of an antimicrobial or antibacterial material. The grate 16 and divider wall 32 may also be made of antimicrobial or antibacterial material,

FIG. 3 is a top left perspective view of the pet litter box 10 nested for shipping in accordance with one embodiment of the invention. This figure shows how the litter box 10 nests for shipping. The upper portion 14 when turned over nests inside the lower portion 12. The divider portion 16 nests inside the upper portion 14.

FIG. 4 is a side view of a cat and is used to illustrate the height of the lower portion 12.

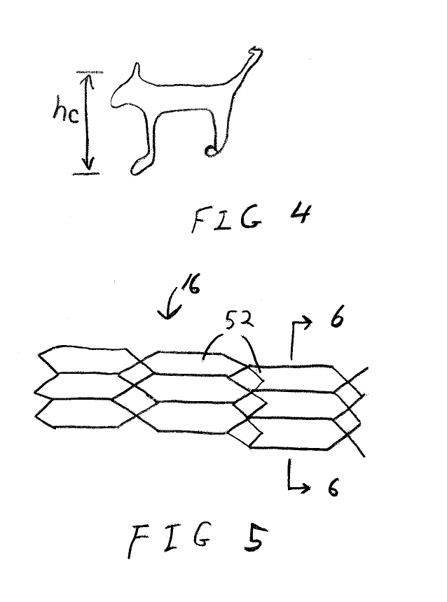

FIG. 5 is a top view of a portion of a floor grate 16 in accordance with one embodiment of the invention. The floor grate 16 is formed of a number of hexagons 52 connected to a series of squares. This structure gently spreads the cat's paws open releasing the kitty litter. The hexagons and squares form a face of the grate 16.

FIG. 6 is a cutaway view of the floor grate of FIG. 5, in accordance with one embodiment of the invention. The walls 54 are not perpendicular to the face of the grate 16. Again this tends to spread the cat's paws and allow kitty litter to release back into the lower portion 22 of the litter box.

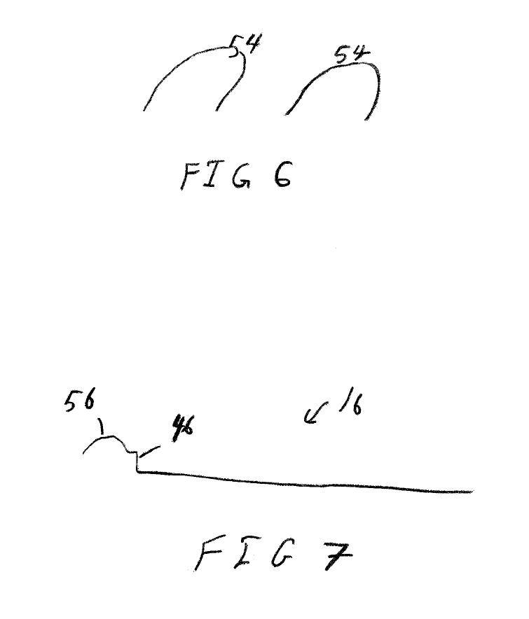

FIG. 7 is a side view section of the floor grate 16 in accordance with one embodiment of the invention. This view shows that grate 16 has a grate lip 56 along one of more of its sides that mates with the lower portion vertical lip 40 to hold the grate 16.

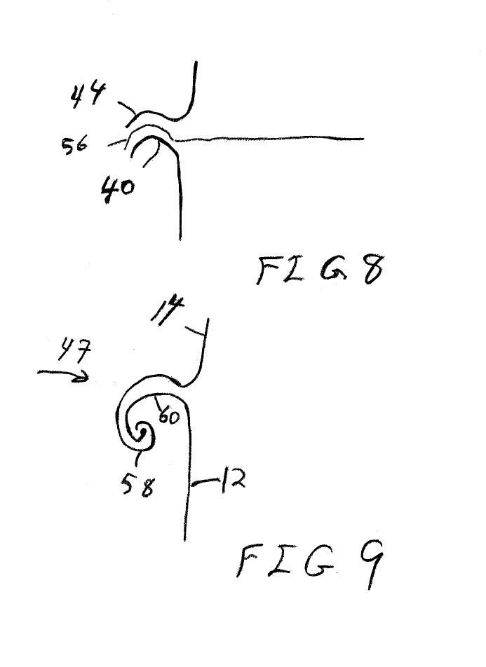

FIG. 8 is a cutaway view of the vertical lips of the pet liter box in accordance with one embodiment of the invention. The lower portion vertical lip 40 mates with the grate vertical lip 56, which mates with vertical lip 44 of the upper portion. Note that if urine happens to hit the upper portion 14 it will be not be able to make it over the grate vertical lip 56, or the lower portion vertical lip 40. As a result, urine is contained inside the litter box. Many previous litter boxes either have horizontal lips and grooves that mate or similar designs that do not provide this advantage. Note that vertical lip means that the lip is pointed up when in normal use.

FIG. 9 is a cutaway view of a hinge 47 in accordance with on embodiment of the invention. The hinge 47 in one embodiment does not have an hinge pin. The upper portion 14 has a spiral structure 58 that mates with a spiral structure 60 of the lower portion 12. When the upper portion 14 is rotated up, its spiral structure 58 is captured in the spiral structure 60 of the lower portion. Note that the invention is not limited to this type of hinge and any hinge may be used with the invention.

In one embodiment, the handles 29 on the upper portion 14 mate with the lower portion in a manner similar to that shown in for the hinge 47 that is the handles snap fit onto the lower lip 40. This allow the user to grab the handles and move the whole litter box 10.

In operation litter is placed in the lower portion 12, with or without a plastic bag. The divider portion 16 is placed on top of the lip 40 of the lower portion 40. Then the upper portion 14 is placed on the lip 40 of lower portion 12. When a cat or other pet needs to use the litter box, they jump from the floor through the opening 28 onto the grate floor 30. Then they walk along the length of the grate floor 30 until they reach the end of the divider wall 32 and jump through the opening formed by the upper portion 14, the grate floor 30, and the divider wall 32 into the lower portion 12 containing the litter. The cat does their business and then jumps from the lower portion 12 onto the grate floor 30 and walks along the length of the litter box and then out of the opening 28 onto the floor. Note that it is impossible for the cat to jump from the lower portion 12 through opening 28 onto the floor, since the cat is forced to turn a corner. As a result, the cat walks along the grate or screen floor 30 causing litter on the cats paws to come loose and fall through the grate down into the lower portion 12. The grate's structure forces the opening of the cat's paw releasing the trapped kitty litter.

The overlap between the lip 40 of the lower portion 12 and the vertical lips 42 and 44 & 56 formed by the upper portion 14 and the divider wall 16, prevents any urine leakage out of the litter box 10 even if in the unlikely event that a cat is able to urinate on the upper portion 14.

Thus there has been described that stops dog snacking, reduces tracking, stops urine leaks, limits circulation of odor and can be shipped inexpensively.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A pet litter box, comprising:
a lower portion having a bottom wall and four lower portion side walls that are at slightly more than ninety degrees from the bottom wall, wherein the lower portion has a length and a width and a lower portion height which is higher than an average height of a cats head;
an upper portion having a top wall and four upper portion side walls, a cutout portion in one of the four upper portion side walls, the four upper side walls terminating in a upper vertical lip that mates with a lower vertical lip formed by the four lower portion side walls; and
an internal divider has a floor grate that extends along the length of the lower portion and has a wall that does not extend the length of the lower portion, a divider groove that mates with the vertical lip of the lower portion, whereby a pet entering or exiting the pet litter box is required to make a turn on the grate.

2. The pet litter box of claim 1, wherein the upper portion has an upper portion height which is less than the height of the lower portion.

3. The pet litter box of claim 2, wherein the lower portion height is at least eight inches.

4. The pet litter box of claim 1, further including a hinge between one of the four lower portion walls and one of the four upper portion walls.

5. The pet litter box 1, wherein the floor grate includes a series of hexagonal opening and a wall of the hexagon is not perpendicular to a face of the floor grate.

6. The pet litter box of claim 5, wherein the floor grate includes a series of square opening attached to some of the series of hexagonal openings.

7. The pet litter box of claim 1, wherein the floor grate has a vertical lip that rests on the vertical lip of the lower portion.

8. The pet litter box of claim 1, further including a plurality of handles on the upper portion that mate with the lower vertical lip.

9. The pet litter box of claim 1, wherein the lower portion is made of an antibacterial material.

10. A pet litter box, comprising:
a lower portion having a base and four lower portion side walls that are at slightly more than ninety degrees from the bottom wall, the four lower portion side walls forming a rectangle with a length and a width, the lower portion having a lower portion height;
a lower portion vertical lip formed on the periphery of the four lower portion side walls;
an upper portion have a top wall and four upper portion side walls, a cutout portion in one of the four upper portion side walls, wherein the four upper portion side walls are not perpendicular to the top wall, the upper portion having an upper portion height which is equal to or less than a lower portion height;
an upper portion vertical lip formed on a periphery of the four upper portion side walls and mating with the lower portion vertical lip;
a floor grate running along the length of the lower portion and having a grate vertical lip that mates with the lower portion vertical lip, the floor grate aligned with the cutout; and
a dividing wall running along a portion of the floor grate, starting at the cutout.

11. The pet litter box of claim 10, wherein a lower portion height is at least ten inches.

12. The pet litter box of claim 10, wherein the upper portion has a first part and a second part and a hinge connects the first part to the second part.

13. The pet litter box of claim 10, wherein the floor grate has a plurality of openings formed by a plurality of walls, wherein plurality of walls are not perpendicular to a face of the grate.

14. The pet litter box of claim 10, a plurality of handles on the upper portion that mate with the lower vertical lip.

15. The pet litter box of claim 10, wherein the upper portion is made of an antibacterial material.

16. The pet litter box of claim 10, further including a storage shelf that snap fits to the lower portion.
